(19) United States
(12) Patent Application Publication
(10) Pub. No.: US 2007/0279231 A1
(43) Pub. Date: Dec. 6, 2007

(54) ASYMMETRIC RFID TAG ANTENNA

(75) Inventors: Chi Ho Cheng, Tseung Kwan O (HK); Ross Murch, Kowloon (HK)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: HONG KONG UNIVERSITY OF SCIENCE AND TECHNOLOGY, Kowloon (HK)

(21) Appl. No.: 11/756,773

(22) Filed: Jun. 1, 2007

Related U.S. Application Data
(60) Provisional application No. 60/810,706, filed on Jun. 5, 2006.

(51) Int. Cl. G08B 13/14; H01Q 9/04

(52) U.S. Cl. 340/572.7; 343/700 MS

(57) ABSTRACT

The invention provides an asymmetric UHF RFID tag antenna that variously comprises a capacitive load, a folded loop conductor and an inductive matching element, which provides a differential input for RFID tag circuitry. The design provides a small form factor while maintaining a high gain and impedance tuning properties. Various refinements and associated devices and systems using the design are provided and disclosed according to a host of optional embodiments.

### CROSS-REFERENCE TO RELATED APPLICATIONS

This application clams the benefit of priority under 35 U.S.C. Section 119 from U.S. Provisional Patent Application Ser. No. 60/810,706 entitled “ASYMMETRIC RFID TAG ANTENNA”, filed on Jun. 5, 2006, the entirety of which is incorporated herein by reference.

### TECHNICAL FIELD

The subject disclosure relates to construction and design of radio frequency identification (RFID) tag antennas and associated devices and systems using the ultra high frequency radio band (UHF).

### BACKGROUND

Recently, RFID systems have become popular for commercial use. Applications include for example intelligent transportation systems (e.g., automobile theft prevention, automated parking, high speed toll collection, traffic management), commerce (e.g., factory automation, inventory management and tracking, merchandise theft prevention, tracking and library book theft prevention, parcel and document tracking, livestock tracking, dispensing goods, controlled ski lift access, fare collection), and security (e.g., access control to buildings and facilities, controlled access to gated communities, corporate campuses, and airports; U.S. Homeland Security applications such as secure border crossing and container shipments with expedited low-risk activities; child or pet tracking).

A typical RFID system comprises for example a simple device on one end of the communication path (e.g., tags or transponders) communicatively coupled to a more complex device (e.g., readers, interrogators, beacons). RFID tags are typically required to be small and inexpensive so that they can be economically deployed on a large scale, are required to be attachable to the tracked objects, and are required to reliably operate automatically in diverse environments. The RFID readers are typically more capable electronic devices and are usually connected to a host computer or host network by either wired or wireless connection. RFID systems can be read-only (data transfer from RFID tag to reader only) or read-write (data can be written to an RFID tag memory e.g., EEPROM).

Conventionally, RFID tags typically consist of two components: a single custom CMOS circuit (e.g., an application specific integrated circuit or ASIC), although other technologies have been used (e.g., surface acoustic wave devices or tuned resonators), and an antenna. Tags can be powered by a battery or other physically connected power source (e.g., in active RFID), by rectification of the radio signal sent by the reader (e.g., in passive RFID), or a combination of the two (e.g., semi-passive RFID). RFID tags typically send data to the reader by changing the loading of the tag antenna in a coded manner or by generating, modulating, and transmitting a radio signal.

As Electronically Erasable Programmable Read Only Memory (EEPROM) nonvolatile memory has become feasible for use in RFID tags, thereby permitting large-scale manufacture of identical individually programmable RFID tags, this lead to further reductions in the size of RFID tag circuitry and increases in their functionality. As a result, the required antenna size is becoming an increasingly important size constraint. The resultant RFID tag size is now constrained by the antenna design. Although the term RFID tag can refer to the entire package (e.g., RFID circuitry and antenna), the term tag will be used hereinafter to refer to the RFID tag circuitry only as distinct from the RFID tag antenna designs and implementations as discussed in further detail below.

Passive RFID tags typically consist of an integrated circuit mounted on a strap that contains an antenna layout. Passive tags, which operate at 125 kHz or 13 MHz, have been developed for many years. Traditionally, passive transponders operating at 125 kHz or 13 MHz used coils as antennas. These transponders operate in the magnetic field of the reader's antenna, and their reading distance is typically limited to less than about 1.2 meters. These systems suffer from low efficiency of more reasonably sized antennas at such low frequencies. Due to the demand for higher data rates, longer reading distances, and small antenna sizes, there is a strong interest in UHF frequency band RFID transponders, especially for the 868/915 MHz and 2.4 GHz Industrial, Scientific and Medical (ISM) bands.

As the demand for longer reading distances has spurred the development of RFID tags that work in 915 MHz and 2.4 GHz ISM bands, this necessitated further development of appropriate antenna designs. Because RF antenna length is inversely proportional to the frequency, the antenna of a passive RFID tag operating in the microwave range has a smaller length, which results in a smaller tag size. As a result, further reductions in RFID tag antenna size are desired.

An appropriately designed antenna faces several design constraints in addition to size and cost of the packaging. For example, the tag antenna must be properly impedance matched to the RFID tag circuitry to maximize the transfer of power into and out of it. This is especially significant for a passive tag where the power to operate the RFID tag circuitry is obtained solely from the RFID reader transceiver electromagnetic (EM) wave and the received power is usually in the order of μW (e.g., assuming 1 W transmit power, 0 dBi antenna gain and 4 meter reading distance). If the passive RFID tag antenna is unable to transfer sufficient energy from the RFID reader transceiver to the tag, the passive RFID tag does not function.

Proper impedance match of the RFID tag antenna to the RFID circuitry (e.g., the ASIC) is of paramount importance in RFID, because new IC design and manufacturing is a complex and costly venture. As a result, RFID tag antennas are designed to adhere to the requirements of a specific ASIC available in the market, because adding an external matching network with lumped elements would be cost prohibitive and more complex to fabricate. As a result, RFID antennas are designed to be directly matched to the RFID tag ASIC, which typically has complex impedance varying with the frequency and the input power applied to the RFID tag.

For example, the typical input impedance of an RFID tag is of real part of around 10 ohm with the reactive part around −j200 ohm. This is because the tag impedance is typically dominated by the Schottky diodes used in the rectifier circuit in the tag. Therefore, it is desired to design an RFID tag antenna with an input impedance of approximately 10+j200 ohm, so that the RFID tag antenna has a conjugate matching with the RFID tag circuitry, resulting in maximum power transfer to the tag. Although, some special dipole antennas have been studied that can achieve the required input impedance, a conventional dipole design length is typically restricted to λ/2 (e.g., approximately 166 millimeters for nominal 900 MHz RFID carrier) for maximum power transfer. Accordingly, further RFID antenna size reductions are desired, which simultaneously maximizes RFID power transfer.

### SUMMARY

In consideration of the foregoing, the invention provides an asymmetric RFID antenna with length smaller than λ/4, which matches input impedance and provides a differential input feed for the RFID tag ASIC operating in 900 MHz and 2.4 GHz ISM bands. In various non-limiting embodiments, the invention provides an RFID antenna having a differential input and an asymmetrical shape. The invention, according to various non-limiting embodiments, advantageously provides construction techniques for short electrical and physical length RFID antennas, which flexibly allows control of the RFID radiation pattern and electrical input impedance characteristics.

According to various non-limiting embodiments, the claimed RFID antenna can be constructed asymmetrically using a capacitive load (e.g., rectangular shaped) in place of one arm of a conventional dipole-like design. The other arm can be folded to form a closed loop with the capacitive load, to reduce the overall length of the structure. Advantageously an inductive matching stub in the folded arm can be used to resonate with the tag capacitance.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

The RFID tag antenna designs and associated devices and systems are further described with reference to the accompanying drawings in which:

FIG. 1 is an exemplary non-limiting block diagram generally illustrating an operating environment suitable for implementation of the present invention;

FIG. 2 is an exemplary non-limiting block diagram generally illustrating the transponder components of an RFID tag suitable for implementation of the present invention;

FIG. 3 is an exemplary non-limiting block diagram generally illustrating an RFID system functional components suitable for reading data from a modulated backscatter RFID tag system according to one aspect of the present invention;

FIG. 4A is an exemplary non-limiting block diagram of an RFID Tag antenna designs according various embodiments of the present invention;

FIG. 4B is an exemplary non-limiting block diagram of RFID Tag antenna design according to a particular embodiment (e.g., 900 MHz ISM band) of the present invention;

FIG. 4C is an exemplary non-limiting block diagram of RFID Tag antenna design according to a particular embodiment (e.g., 2.4 GHz ISM band) of the present invention;

FIG. 5A is a further non-limiting block diagram of an RFID Tag antenna designs according various embodiments of the present invention;

FIG. 5B is an exemplary non-limiting block diagram of RFID Tag antenna design according to a particular embodiment of the present invention;

FIGS. 6A-6B depict further non-limiting embodiments of RFID Tag antenna designs according various embodiments of the present invention;

FIG. 7 is a graph illustrating typical differential input impedance characteristics as a function of frequency for a particular non-limiting embodiment of the present invention;

FIG. 8 is a graph illustrating the effect of varying the dimension L2 in FIG. 4A on the differential input impedance characteristics, according to various non-limiting embodiments of the present invention;

FIG. 9 is a graph illustrating the effect of varying the dimension L1 in FIG. 4A on the differential input impedance characteristics, according to various non-limiting embodiments of the present invention;

FIG. 10 is a graph illustrating the effect of varying the dimension L3 in FIG. 4A on the differential input impedance characteristics, according to various non-limiting embodiments of the present invention;

FIG. 11A is a graph illustrating simulated radiation pattern in the X-Z plane according to a particular non-limiting embodiment of the present invention;

FIG. 11B is a graph illustrating simulated radiation pattern in the Y-Z plane according to a particular non-limiting embodiment of the present invention;

FIG. 12A is a graph illustrating the effect of varying the dimension L1 in FIG. 5A on the differential input impedance characteristics, according to various non-limiting embodiments of the present invention;

FIG. 12B is a graph illustrating the effect of varying the dimension L2 in FIG. 5A on the differential input impedance characteristics, according to various non-limiting embodiments of the present invention;

FIG. 13 is a block diagram representing an exemplary non-limiting networked environment in which the present invention may be implemented; and

FIG. 14 is a block diagram representing an exemplary non-limiting computing system or operating environment in which the present invention may be implemented.

### DETAILED DESCRIPTION

### Overview

As discussed in the background, RFID tag size is constrained by the RFID tag antenna design, which in turn is constrained by the requirement to provide maximum power transfer (e.g., by impedance matching) to the RFID tag ASIC.

Accordingly, the invention provides an asymmetric RFID antenna with length smaller than λ/4, which achieves the requirement of matching input impedance and provides a differential input feed for the RFID tag ASIC operating in 900 MHz and 2.4 GHz. ISM bands.

As will be described in further detail below, according to various non-limiting embodiments, the antenna can be attached to the two input ports of a tag rectifier circuit, which does not contain a ground port. Similar to a conventional dipole antenna, the invention advantageously provides balanced operation of the RFID tag. However, unlike a conventional dipole design, the length of the RFID antenna of the present invention, according to various non-limiting embodiments, is not restricted by λ/2 to achieve a high power transfer.

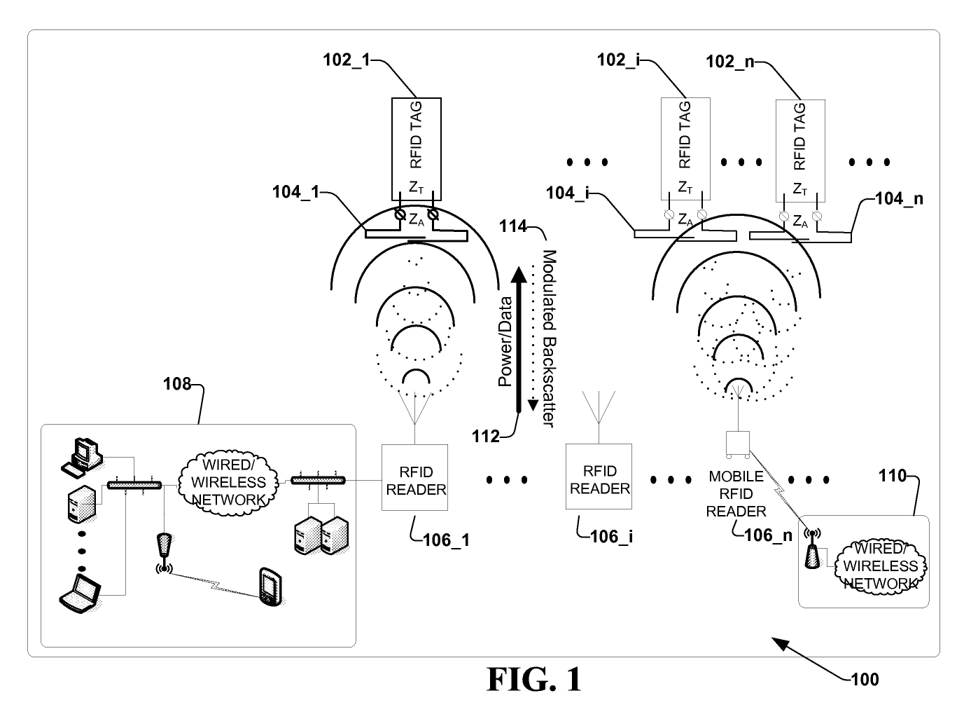

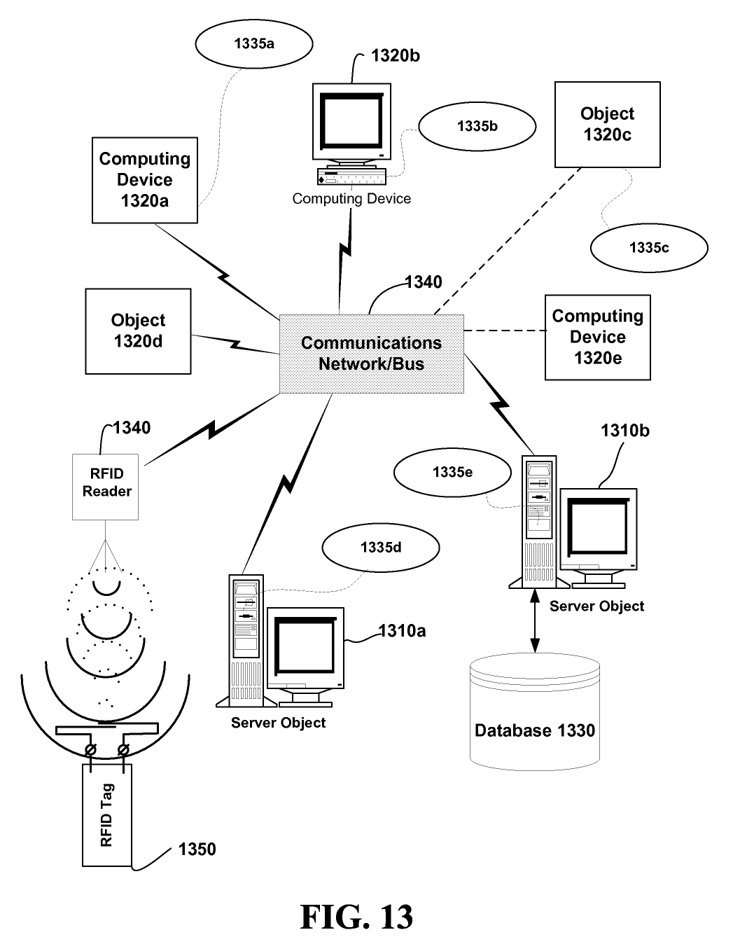

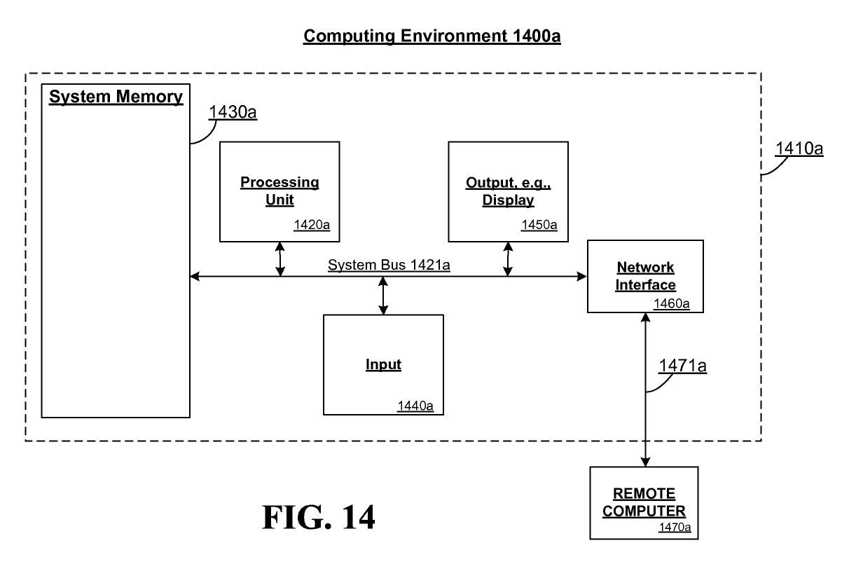

FIG. 1 is an exemplary non-limiting block diagram generally illustrating an operating environment suitable for implementation of the present invention. An operating RFID system typically comprises an RFID tag (e.g., RFID tag antenna 104 communicatively coupled to the RFID tag ASIC 102) in the presence of an RFID reader 106. The RFID reader 106 exposes the RFID tag (102, 104) to EM radiation intended to activate the RFID tag (102, 104), which then takes the desired action (e.g., returning an encoded data signal to the reader to accomplish inventory control, toll collection, etc.). Although the RFID reader 106 can be a standalone device, typically the reader is connected to external systems (e.g., 108, 110) to achieve the purposes as described above. For example, the data received by the reader may be transferred to systems 108 or 110 for the purposes of data storage and analysis, or to trigger a further action (e.g., debiting an account, reordering depleted inventory, triggering a downstream manufacturing step, etc.). Such external connections and associated operations are further described below with reference to FIGS. 13-14. Additionally, an RFID reader can take any form that provides the suitable functionality for reading the RFID tag (e.g., a PCMCIA RFID reader card connected to a computing device, a handheld reader, a fixed self-contained reader with or without external connections). Although for the present purposes, FIG. 1 shows a limited number of RFID readers 106 and RFID tags (102, 104), a typical implementation is not so limited, as any number and combination of reader, tags, and external connections may exist according to the intended function of the system design.

As an example, a passive back-scattered RFID system 100 typically operates as follows. The RFID reader 106 transmits a modulated signal 112 (illustrated by the solid lines emanating from the RFID reader 106 antenna) with periods of unmodulated carrier, which is received by the RFID tag antenna 104. The RF voltage developed on antenna terminals during unmodulated period is converted to dc. This voltage powers up the RFID tag ASIC 102, which sends back the information stored in the RFID tag ASIC by varying its front end complex RF input impedance. The impedance typically toggles between two different states (e.g., between conjugate match and some other impedance) effectively modulating the back-scattered signal 114 (illustrated by the dotted lines emanating from the RFID tag antenna 104).

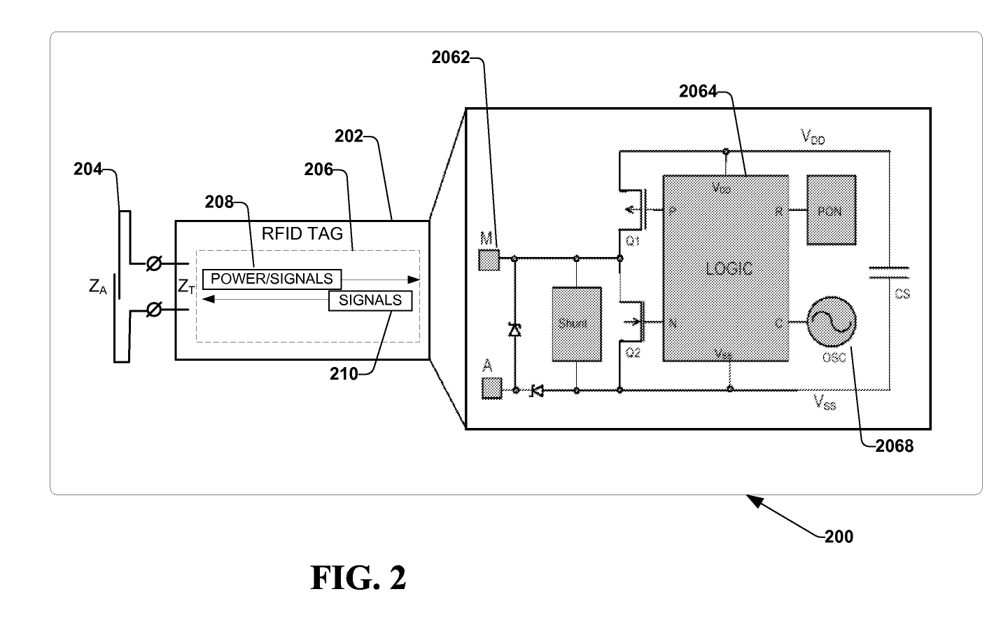

FIG. 2 is an exemplary non-limiting block diagram generally illustrating transponder components 206 of an RFID tag 202 suitable for implementation of the present invention. Accordingly, power and optionally data signals received by the RFID tag antenna 204 pass into the RFIG tag ASIC components for the purpose of powering up the RFID tag 202 and taking the desired action (e.g., returning the desired data signals 210). For example, the RFID reader 106 typically transmits a high frequency, high energy signal that is absorbed by the RFID tag 202 through the RFID tag antenna 204. The RFID tag 202 control logic 2064 powers up and transmits a small energy data signal 210 (e.g., an RFID tag ID programmed in the RFID tag ASIC) to the transceiver. The RFID reader 106 gets the signal (e.g., the transmitted RFID tag ID) and performs some operation or triggers some application.

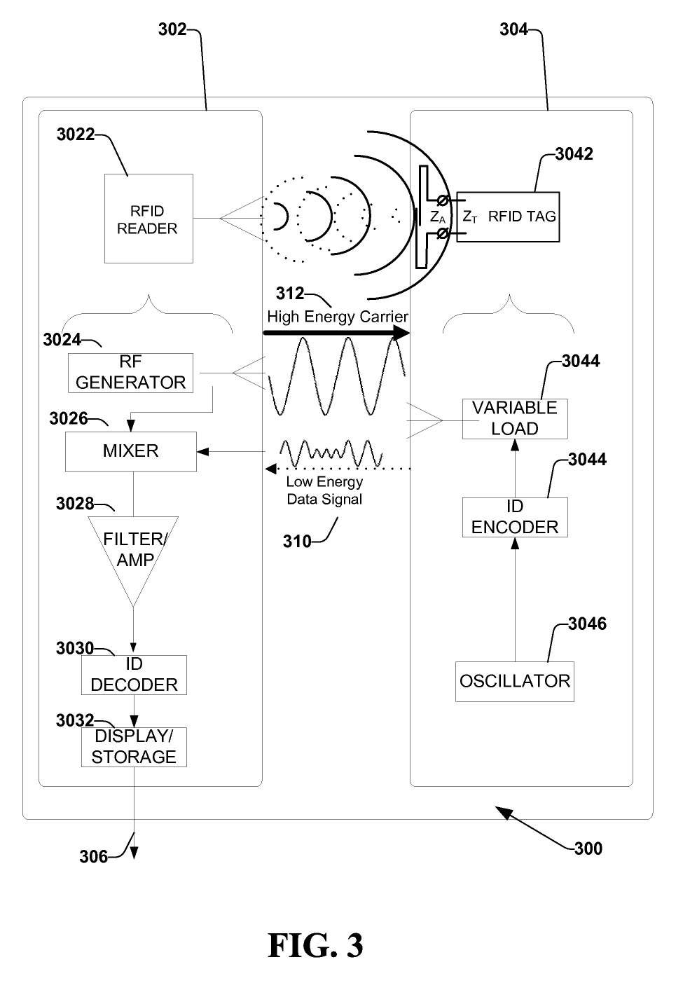

FIG. 3 is an exemplary non-limiting block diagram generally illustrating RFID system functional components suitable for reading data from a modulated backscatter RFID tag system according to one aspect of the present invention. For example, a typical passive RFID system 300 using modulated backscatter operates as follows. To transfer data from the RFID tag (304) to the RFID reader 302, the reader 302 sends an unmodulated signal 312 (illustrated by the solid lines emanating from the RFID reader 3022 antenna) to the RFID tag 3042. The RFID tag 3042 reads its internal memory of stored data and changes the loading on the RFID tag antenna 3044 in a coded manner corresponding to the stored data. The signal reflected from the RFID tag (304) (illustrated by the dotted lines emanating from the RFID tag antenna 3042) is thus modulated with this coded information. This modulated signal 312 is received by the RFID reader 3026, demodulated using a receiver (e.g., a homodyne receiver), and decoded 3030 and output as digital information that contains the data stored in the tag. To send data from the RFID reader 302 to the RFID tag (3044), the RFID reader 302 can modulate (e.g., using amplitude modulation) its transmitted radio signal 312. This modulated signal can be received by the RFID tag (304) and detected (e.g., with a diode detector). The data can be used to control operation of the RFID tag 304, or the RFID tag 304 can store the data. As discussed above, the RFID reader can provide the RFID data to external sources at 306.

### Asymmetric RFID Tag Antenna

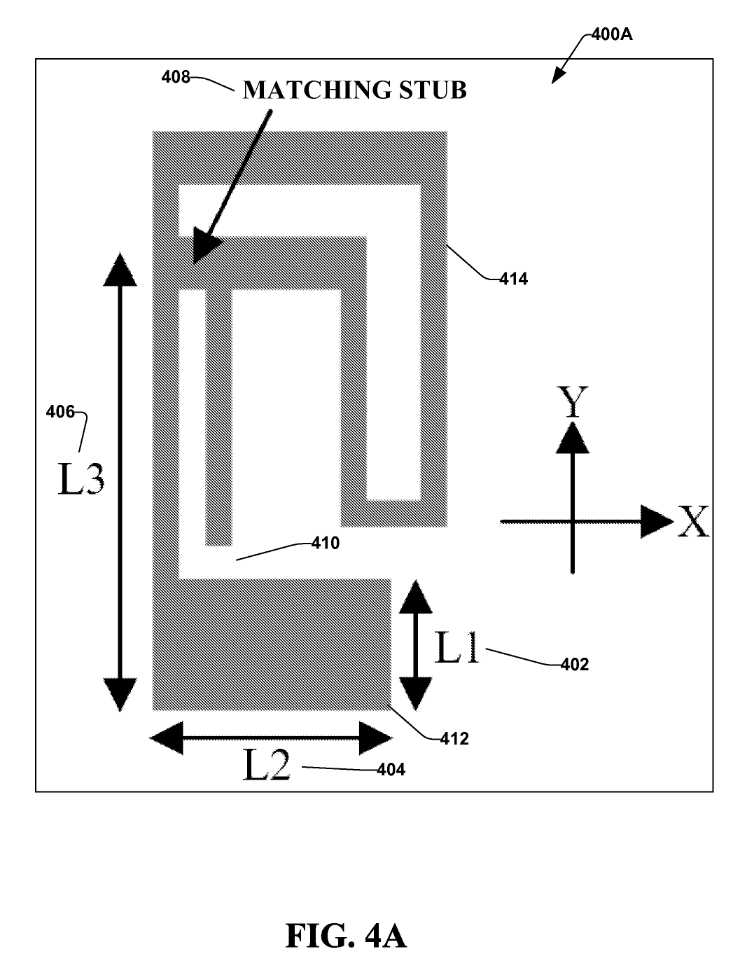

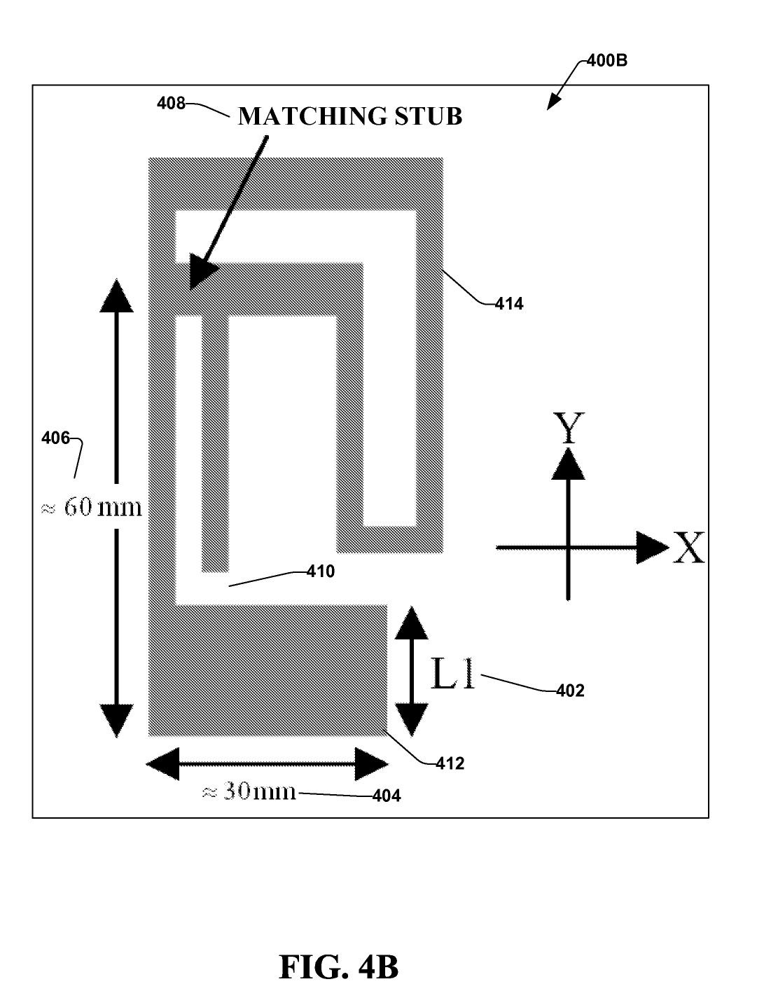

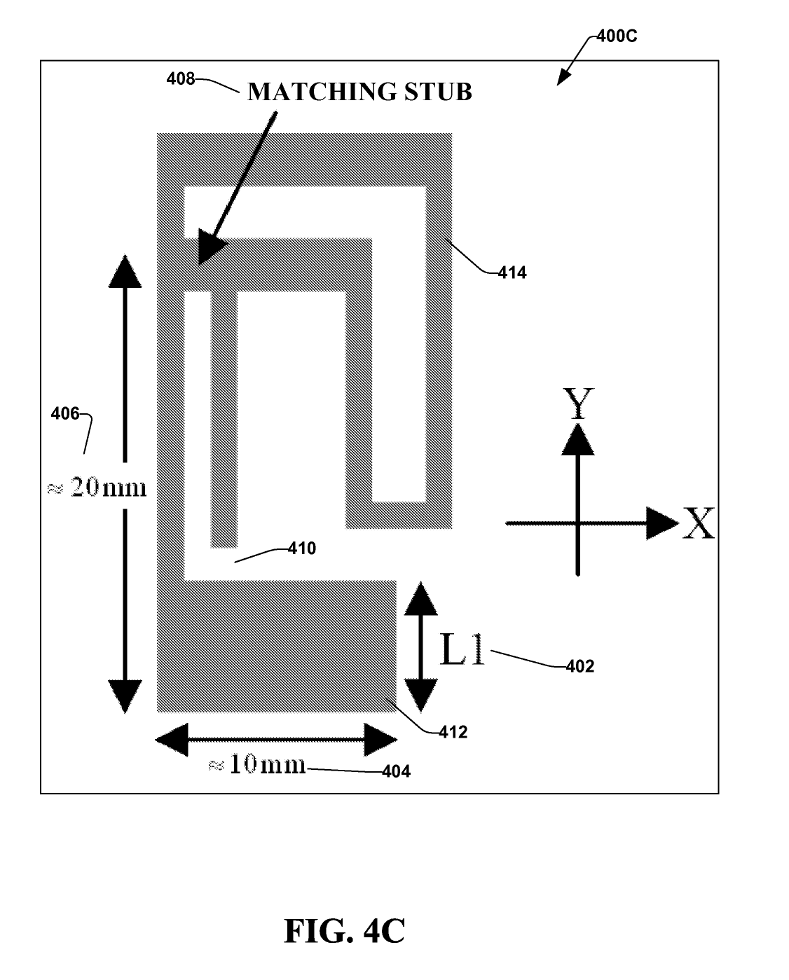

FIG. 4A is an exemplary non-limiting block diagram of RFID tag antenna design according various embodiments of the present invention. According to one embodiment the antenna 400A can comprise a copper conducting pattern supported by an appropriate substrate. The structure is asymmetric with respect to the input port location 410 (e.g., RFID tag circuitry location). According to various non-limiting embodiments, the invention provides an asymmetric RFID antenna with length 406 smaller than λ/4, which achieves the requirement of matching input impedance and provides a differential input feed for the RFID tag ASIC operating in 900 MHz and 2.4 GHz ISM bands in a small form factor. According to further non-limiting embodiments, the claimed RFID antenna can be constructed asymmetrically using a capacitive load (e.g., rectangular shaped) in place of one arm of a conventional dipole-like design. The other arm can be folded to form a closed loop with the capacitive load, to reduce the overall length of the structure. Advantageously, an inductive matching stub in the folded arm can be used to resonate with the tag capacitance, according to various non-limiting embodiments.

In various non-limiting embodiments, the invention provides an RFID antenna having a differential input and an asymmetrical shape. The invention, according to various non-limiting embodiments, advantageously provides construction techniques for short electrical and physical length RFID antennas, which flexibly allows control of the RFID radiation pattern and electrical input impedance characteristics.

According to various non-limiting embodiments, the antenna can be attached to the two input ports of a tag rectifier circuit, which does not contain a ground port. Similar to a conventional dipole antenna, the invention advantageously provides balanced operation of the RFID tag. However, unlike a conventional dipole design, the length of the RFID antenna of the present invention, according to various non-limiting embodiments is not restricted by λ/2 to achieve a high power transfer.

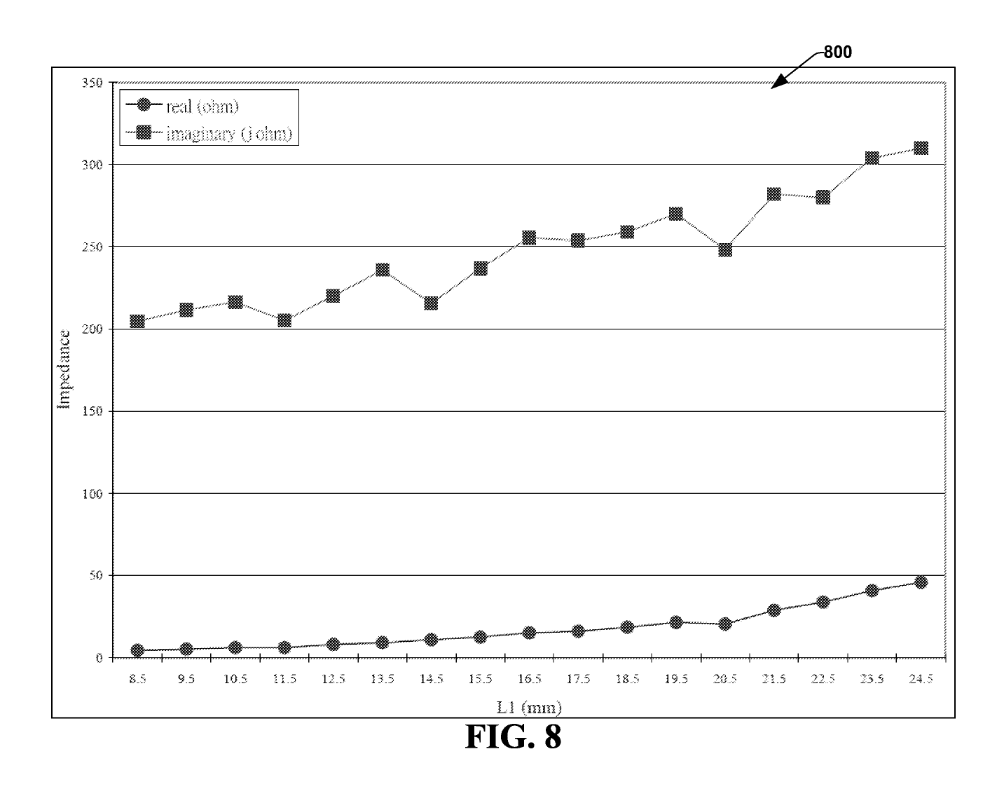

According to various non-limiting embodiments, the configuration of the asymmetric RFID tag antenna is shown in FIG. 4A. Unlike conventional dipole antennas, which require length of approximately λ/2, one arm 412 is replaced by a capacitive load (e.g., a rectangular capacitive load). The other arm 414 is folded and forms a close loop with the capacitive load. In the folded arm 414, there is an inductive matching stub 408 that is used to resonate with the tag capacitance. The folded arm 414 is bent so as to reduce the overall length of the structure. Because the tag circuitry (not shown) consists of a small ASIC (e.g., small compared to wavelength of the incident RF field transmitted to the RFID tag), according to various non-limiting embodiments of the invention, the RFID tag ASIC can be treated as a RF signal source without a ground plane. As a result, the asymmetric RFID antenna design provides a balanced differential feed 410 for the tag chip. The RFID antenna of the present invention is further characterized in that the chip dimensions in the X-Y plane are given by the tunable parameters L1 (402), L2 (404), and L3 (406). According to various non-limiting embodiments, the impedance can be tuned by the different parameters (402, 404, 406) to adapt the asymmetric RFID antenna to different RFID ASIC input impedance. For example, as detailed in FIGS. 8-10 below, when the length of L1, L2 is increased, both the real part and imaginary part of the asymmetric RFID antenna will generally increase. When the matching stub is moved downward (e.g., L3 is decreased) the imaginary part will decrease significantly and vice versa.

Particular embodiments are described below with reference to the applicable figures. Except where specified below, the description of FIG. 4A is applicable to the following particular embodiments.

FIG. 4B is an exemplary non-limiting block diagram of RFID Tag antenna design 400B according to a particular embodiment (e.g., 900 MHz ISM band) of the present invention. For a 900 MHz design with input impedance of around 10+j200 ohm, the overall length (L3 406) is approximately 60 mm and the width (L2 404) is approximately 30 mm. The design is able to match different input impedance of the RFID tag ASICs by simply tuning the stub L3, L1, or L2. λ/4 for a nominal 900 MHz design is approximately 83 millimeters.

FIG. 4C is an exemplary non-limiting block diagram of RFID Tag antenna design 400C according to a particular embodiment (e.g., 2.4 GHz ISM band) of the present invention. Because there is a strong interest in developing passive RFID tags in the 2.4 GHz ISM band, according to a particular embodiment, scaling of the design can be performed for an asymmetric RFID antenna design operating in the 2.4 GHz ISM band. The resulting length (L3 406) and width (L2 404) is approximately 20 mm and approximately 10 mm respectively as illustrated in FIG. 4C and the input impedance is retained around 10+j200 ohm. As above, the design is able to match different input impedances of the various RFID tag circuitry by simply tuning the stub L3, L1, or L2. λ/4 for a nominal 2.4 GHz design is approximately 31 millimeters.

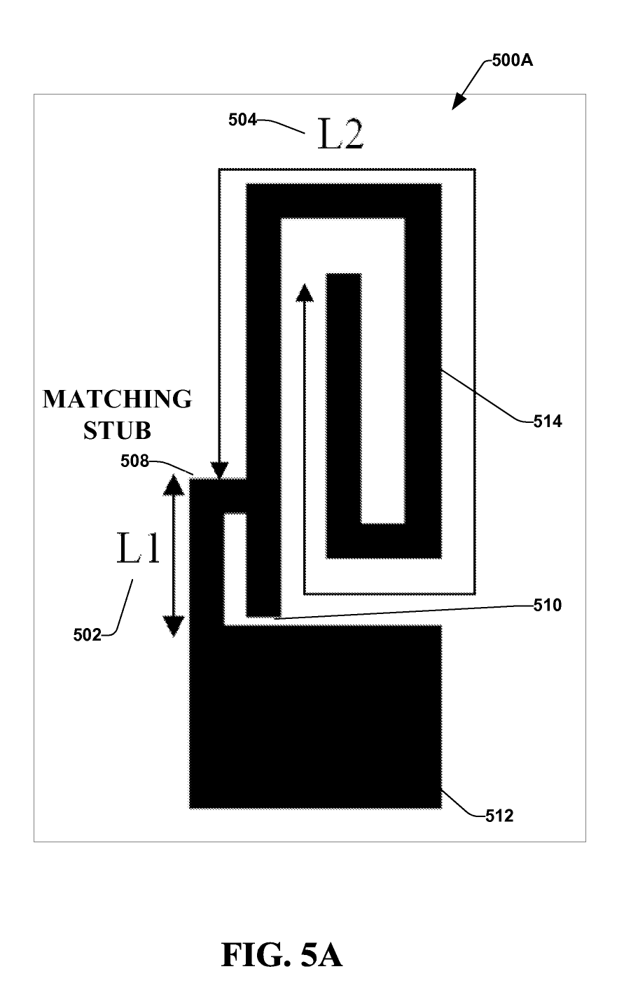

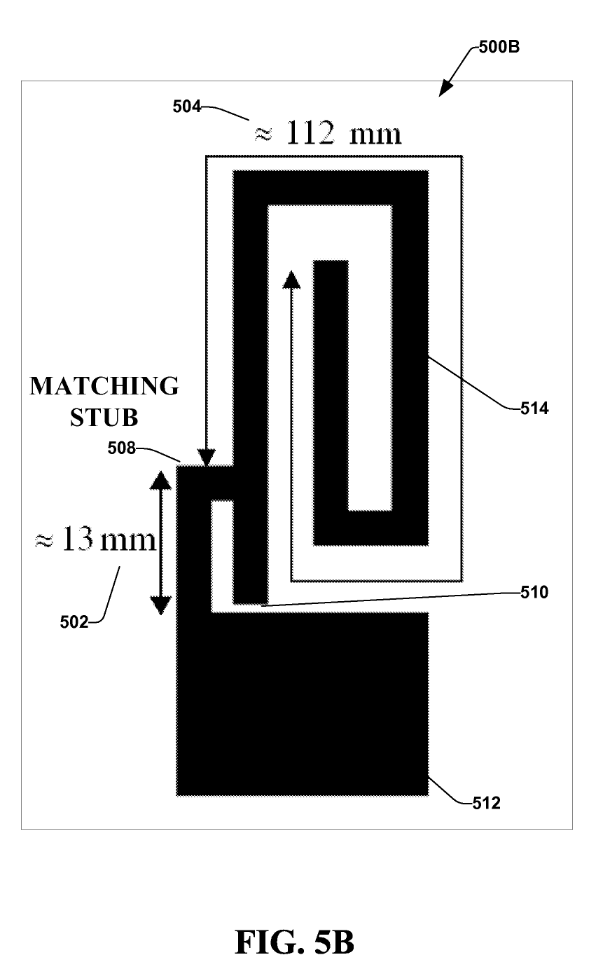

According to further non-limiting embodiments, the configuration of an asymmetric RFID tag antenna is shown in FIG. 5A. Similar to a conventional dipole antenna, the invention advantageously provides balanced operation for the RFID tag. However, unlike a conventional dipole design, the length of the RFID antenna of the present invention, according to various non-limiting embodiments is not restricted by λ/2 to achieve a high power transfer. Accordingly, one arm 512 is replaced by a capacitive load (e.g., a rectangular or polygonal capacitive load). The other arm 514 is folded and forms a close loop with the capacitive load. In the folded arm 514, there is an inductive matching stub 508 that is used to resonate with the tag capacitance. The folded arm 514 is bent so as to advantageously reduce the overall length of the structure. Because the tag circuitry (not shown) consists of a small ASIC (e.g., small compared to wavelength of the incident RF field transmitted to the RFID tag), according to various non-limiting embodiments of the invention, the RFID tag ASIC can be treated as a RF signal source without a ground plane. As a result, the asymmetric RFID antenna design provides a balanced differential feed 510 for the tag chip.

Particular embodiments are described below with reference to the applicable figures. Except where specified below, the description of FIG. 5A is applicable to the following particular embodiment.

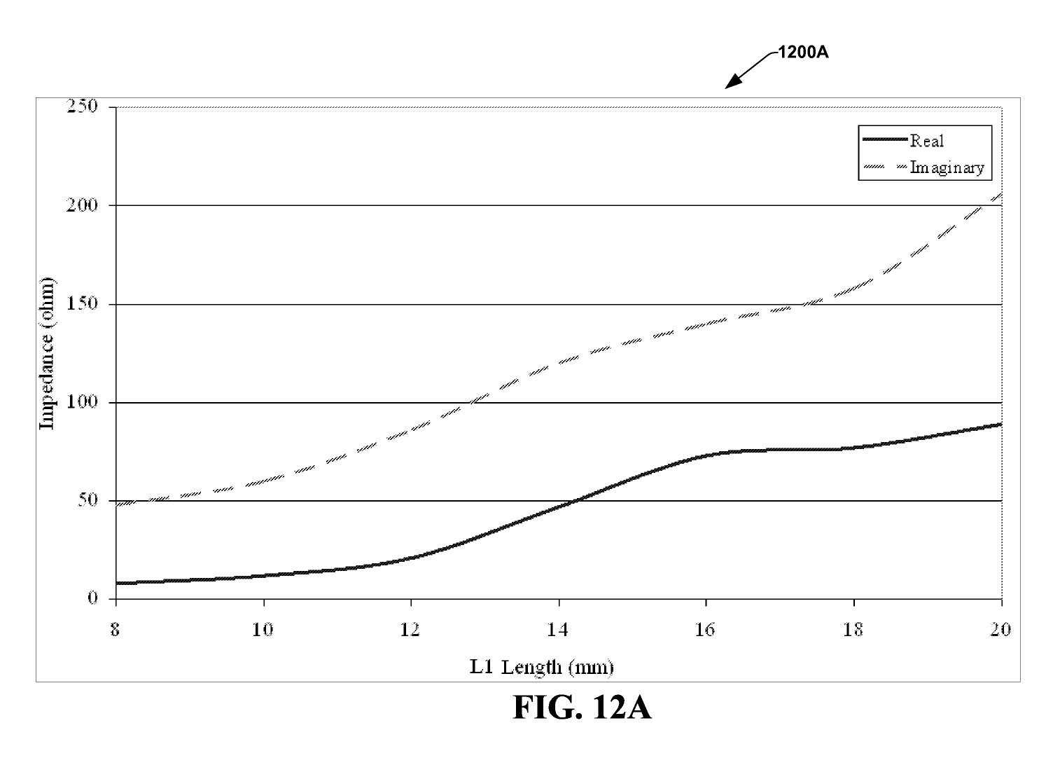

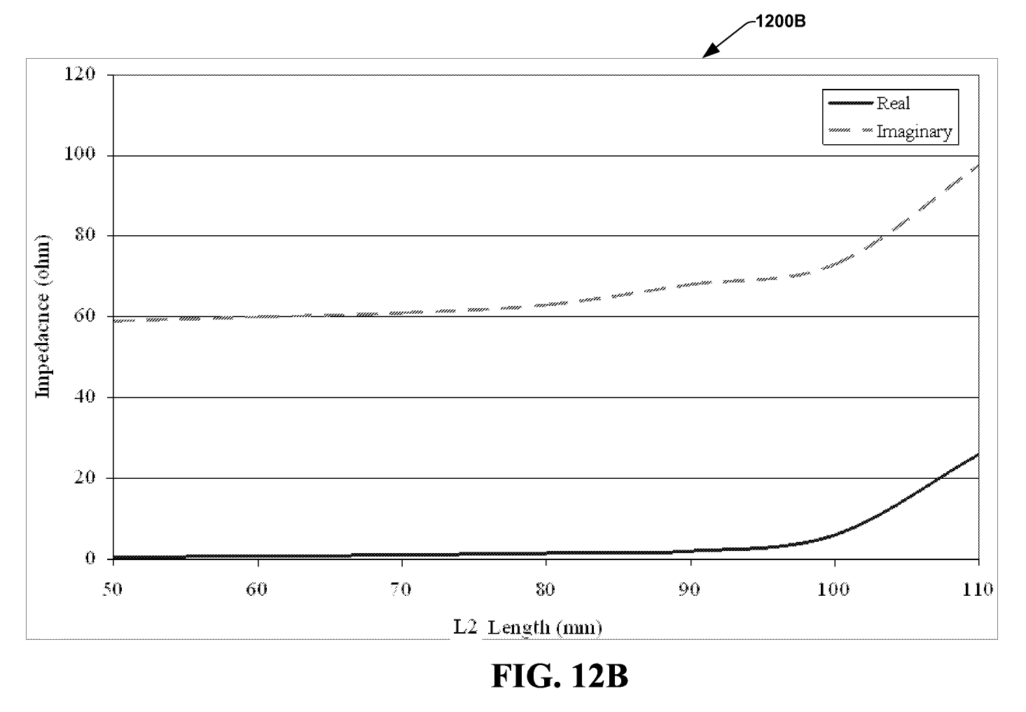

FIG. 5B is an exemplary non-limiting block diagram of an RFID Tag antenna design 500B according to a particular embodiment of the present invention. For example, the antenna can be matched to a RFID chip having an input impedance of about 30−110j ohm in the RFID frequency band. For conjugate matching, the RFID tag antenna design of the present invention can be configured to have an input impedance around 30+j110 ohm. In the particular embodiment of FIG. 5B, L1 (502) and L2 (504) is approximately 13 mm and 112 mm respectively, and resulting in an approximate overall length of 55 mm and an approximate overall width of 22 mm. By varying L1 (502) and L2 (504), it is possible to tune the impedance to different values and match with different RFID chips. For example, as detailed in FIGS. 12A-12B below, when the length of L1 (502) or L2 (504) is increased, both the real part and imaginary part of the asymmetric RFID antenna increase.

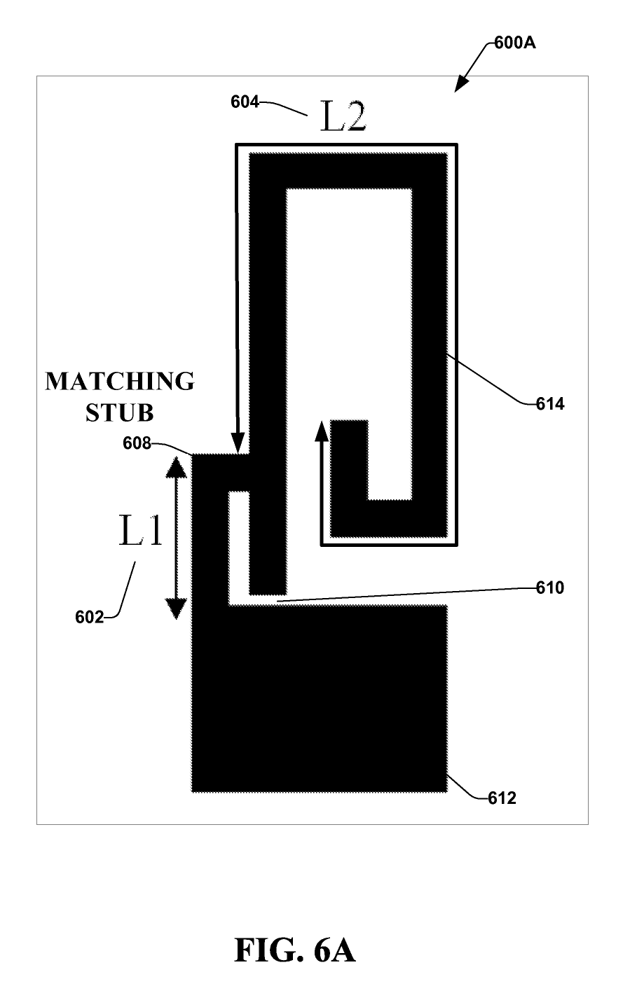

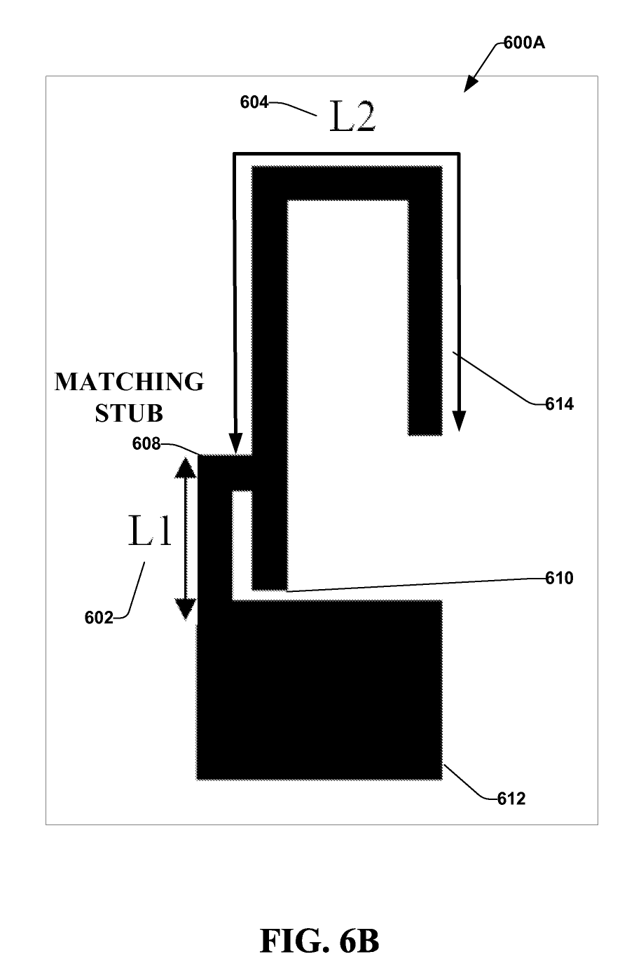

As RFID tag performance can also depend on the product package, the cabinet, and the surrounding environment further modifications of RFID antenna design may be needed. Accordingly, in further non-limiting embodiments of the present invention, L2 can be varied according to the configurations shown in FIGS. 6A-6B (e.g., to account for the various environment considerations). Although particular configurations are depicted in FIGS. 6A-6B, it will be obvious to one skilled in the art that other configurations are possible without departing from the scope of the claimed invention.

In further non-limiting embodiments, the invention provides an asymmetric radio frequency identification (RFID) tag antenna comprising a polygon-shaped capacitive load, a folded arm that forms a closed loop with the polygon-shaped load, the folded arm having an inductive matching stub that is used to resonate with a capacitance of a chip tag, the loop having a length and a location for receiving the chip tag. The antenna may be an ultra high frequency (UHF) tag antenna and may be for a passive RFID tag. The polygon-shaped capacitive load may be rectangular and the length of the loop can be determined based on a function of a kind of backing material (e.g., cardboard, metal, plastic, cloth, ceramic, or glass) of the antenna. The length of the loop may be determined based on proximity to a high dielectric material and in one embodiment, is no greater than one quarter of an operating wavelength of the antenna.

In another embodiment of a method of the invention, a method for transponding with a radio frequency identification (RFID) tag is provided including transmitting at a predetermined frequency to power an RFID tag having an asymmetric antenna, the asymmetric antenna having a polygon-shaped capacitive load and a folded arm that forms a closed loop with the polygon-shaped load, receiving back-scattering from the RFID tag and analyzing the received back-scattering received using a spectrum analyzer. The method may include positioning the RFID tag at least about 2 centimeters from any metal plane and the transmitting can include transmitting at a predetermined frequency to power an RFID tag occurs at a distance of least greater than about 1 meter from the RFID tag.

### Results

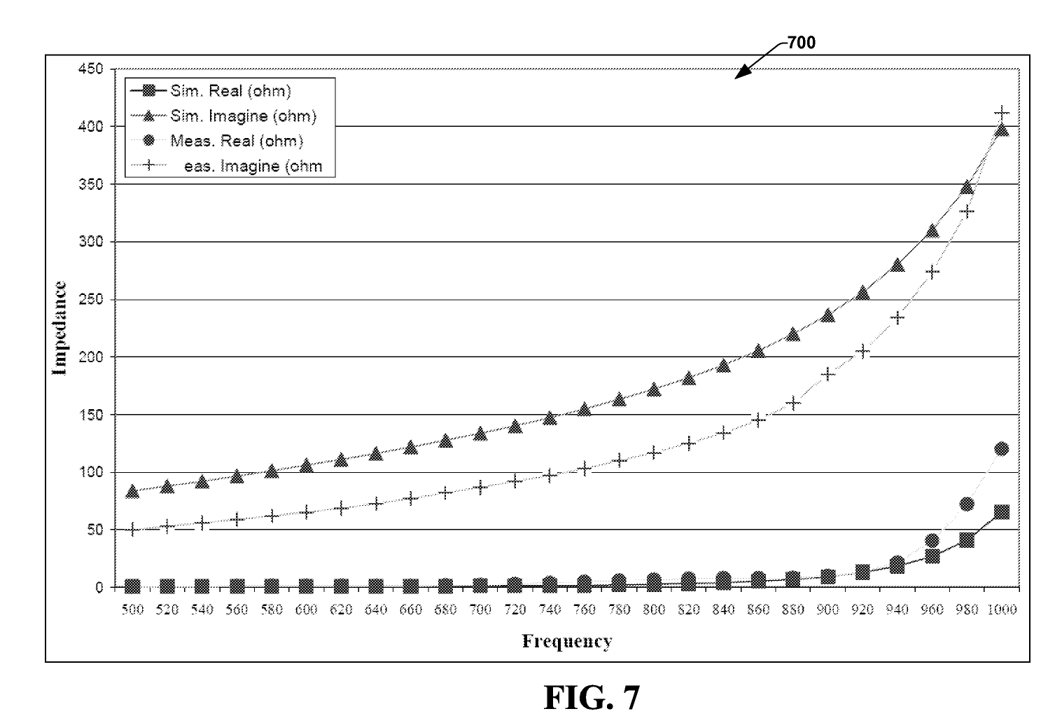

Results for the input impedance and radiation patterns are provided by simulation and measurement. For measurement, a balun is used and the input impedance is measured by a network analyzer. FIG. 7 is a graph illustrating typical differential input impedance characteristics as a function of frequency for a particular non-limiting embodiment of the present invention. FIG. 7 shows the simulated and measured results of a tag antenna for 0.5 GHz to 1 GHz. The measured impedance is approximately 10+j200 ohms. Square and triangular lines represent the simulated real and imaginary part. Dotted and Plus line represent the measured real and imaginary part.

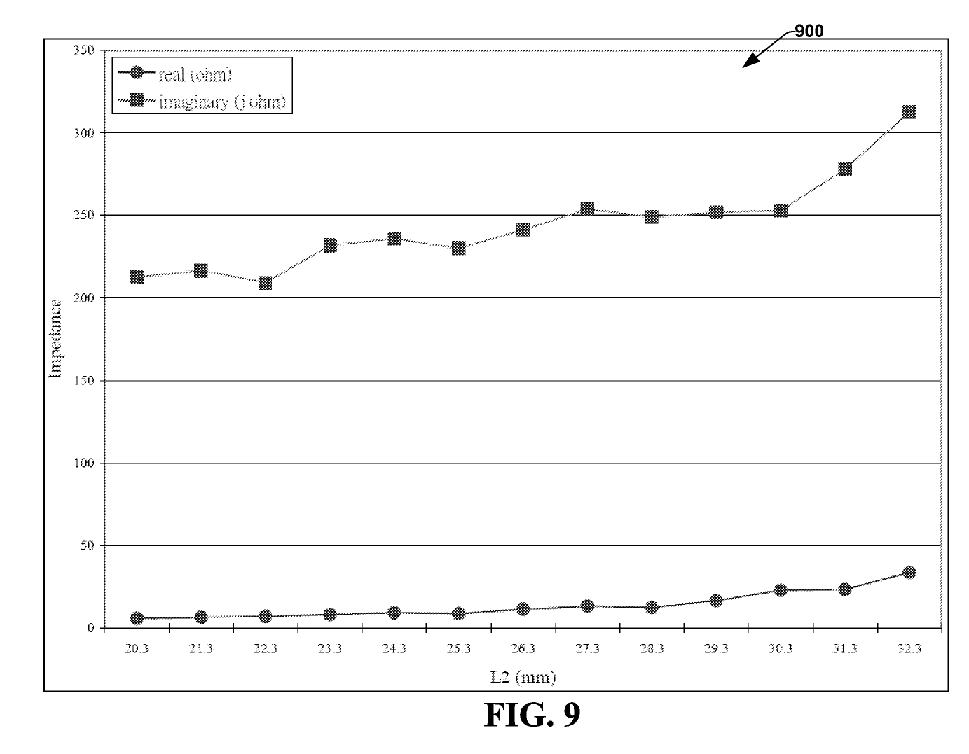

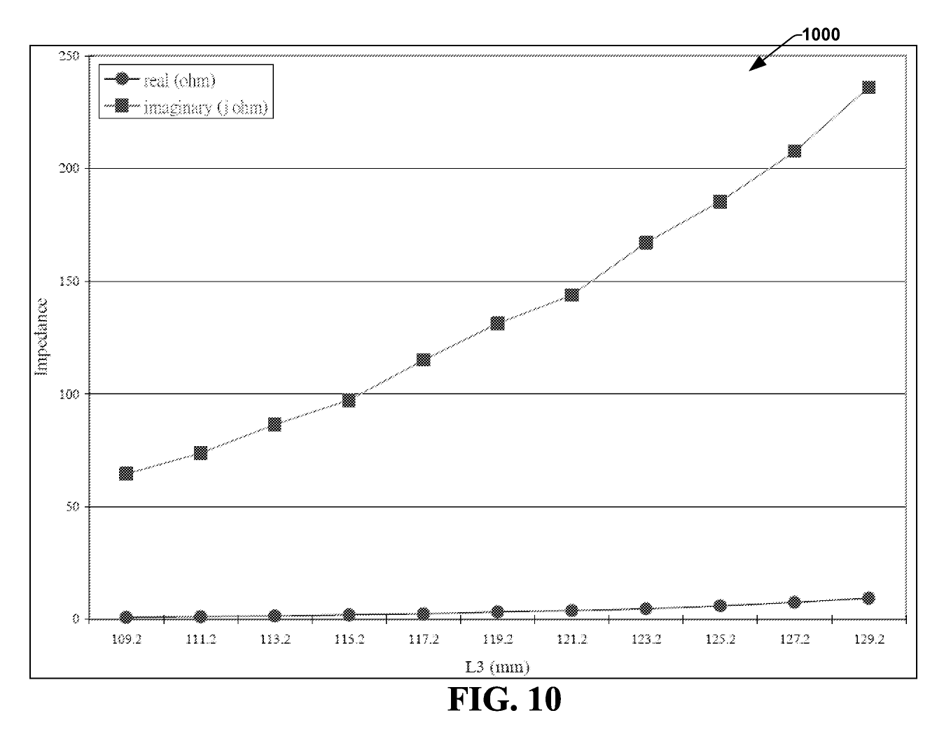

In addition in FIGS. 8-10, the simulated impedance is shown as a function of the stub location L3, L1, L2 of FIG. 4A. In general, when the length of L1, L2 increase, both the real part and imaginary part will increase. When the matching stub is moved downward (e.g., decreasing L3), the imaginary part will decrease significantly and vice versa. Accordingly, FIG. 8 is a graph illustrating the effect of varying the dimension L1 in FIG. 4A on the differential input impedance characteristics, according to various non-limiting embodiments of the present invention. As can be seen, both the real and imaginary part increases with increasing dimension L1 advantageously providing one tuning parameter for the asymmetric RFID antenna. FIG. 9 is a graph illustrating the effect of varying the dimension L2 in FIG. 4A on the differential input impedance characteristics, according to various non-limiting embodiments of the present invention. As can be seen, both the real and imaginary part increases with increasing dimension L2 advantageously providing a further tuning parameter for the asymmetric RFID antenna. FIG. 10 is a graph illustrating the effect of varying the dimension L3 in FIG. 4A on the differential input impedance characteristics, according to various non-limiting embodiments of the present invention. As can be seen, both the real and imaginary part decreases with decreasing dimension L3 (e.g., adjusting the matching strip position as described above) advantageously providing a further tuning parameter for the asymmetric RFID antenna.

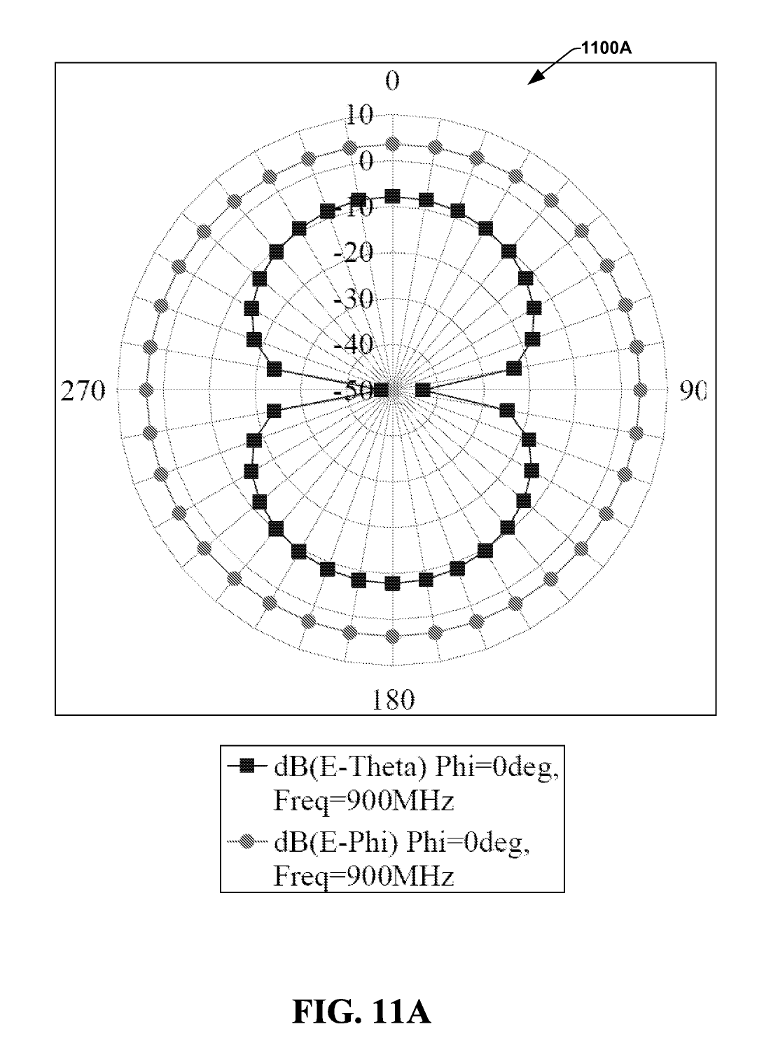

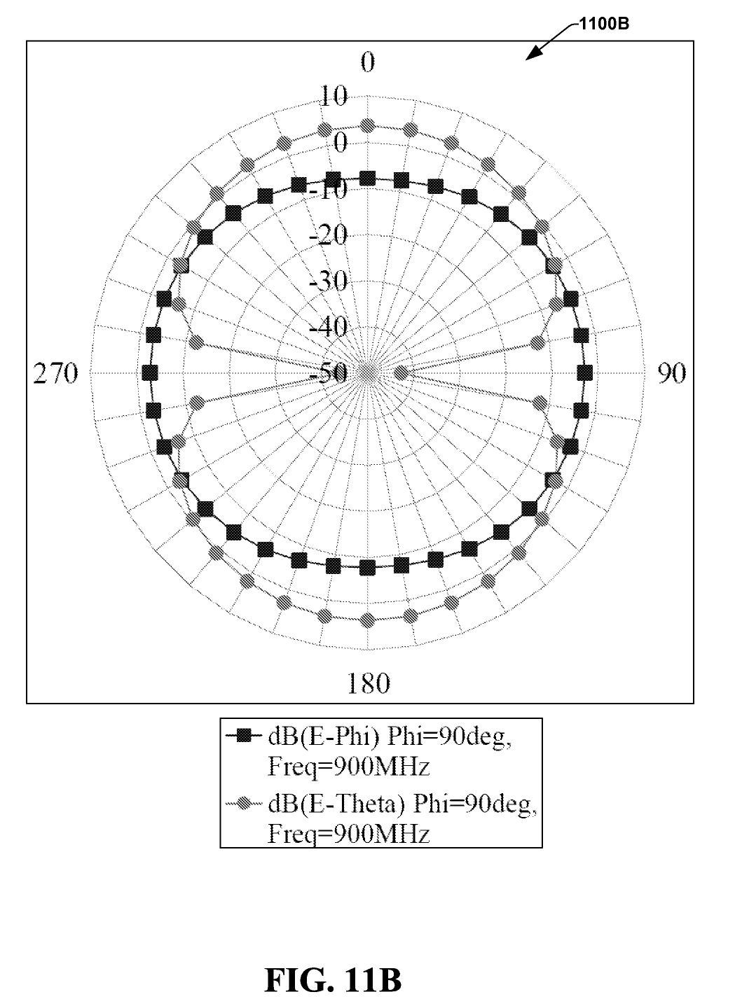

The simulated and measured asymmetric RFID antenna radiation pattern in the X-Z and Y-Z plane is shown in FIGS. 11A-11B. The pattern is measured by matching the input impedance to 50 ohm first before testing in an anechoic chamber. As can be seen, the radiation pattern is similar to a normal dipole, but with a smaller antenna gain of around 1 dBi. The bent arm produces a compact tag antenna, but at a loss of some gain. Accordingly, FIG. 11A is a graph illustrating simulated radiation pattern in the X-Z plane according to a particular non-limiting embodiment of the present invention. FIG. 11B is a graph illustrating simulated radiation pattern in the Y-Z plane according to a particular non-limiting embodiment of the present invention.

FIGS. 12A-12B show the simulated impedance as a function of the stub location L1 (502) and length (L2 (504)) of the folded arm 514 in FIG. 5A. In general, when the length of L1 (602) or L2 (604) is increased, both the real part and imaginary part of the asymmetric RFID antenna increase. Additionally, when the impedance matching stub 508 is located closer to the feed 510, the imaginary part of the impedance decreases significantly and vice versa.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, some aspects of the present invention pertains to any computer system or environment having any number of memory or storage units, and any number of applications and processes occurring across any number of storage units or volumes, which may be used in connection with an RFID system employing the antenna designs in accordance with the present invention. Some aspects of the present invention may apply to an environment with server computers and client computers deployed in a network environment or a distributed computing environment, having remote or local storage. Various portions of the present invention may also be applied in standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise.

FIG. 13 provides a schematic diagram of an exemplary networked or distributed computing environment further describing the possible RFID system external connections (108 and 110) of FIG. 1. The RFID reader 1340 may store, transmit, display, or otherwise process the data obtained from the RFID tag 1350 using the distributed computing environment. Similarly, various components of the exemplary computing environment may be used to control components of the disclosed RFID system. For example, in a RFID enable manufacturing assembly line containing RFID tagged objects, an object passing a particular manufacturing or testing stage may have its RFID tag read or written to allow subsequent inventory management or manufacturing control (e.g., a tagged object marked as failing can be identified and routed as it passes the appropriate failure analysis module in a manufacturing plant).

Accordingly, the distributed computing environment comprises computing objects 1310a, 1310b, etc. and computing objects or devices 1320a, 1320b, 1320c, 1320d, 1320e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1340. This network may itself comprise other computing objects and computing devices that provide services to the system of FIG. 13, and may itself represent multiple interconnected networks. In accordance with an aspect of the invention, each object 1310a, 1310b, etc. or 1320a, 1320b, 1320c, 1320d, 1320e, etc. may contain an application that might make use of an API, or other object, software, firmware and/or hardware, suitable for use with the disclosed systems of the invention.

It can also be appreciated that an object, such as 1320c, may be hosted on another computing device 1310a, 1310b, etc. or 1320a, 1320b, 1320c, 1320d, 1320e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 13, as an example, computers 1320a, 1320b, 1320c, 1320d, 1320e, etc. can be thought of as clients and computers 1310a, 1310b, etc. can be thought of as servers where servers 1310a, 1310b, etc. maintain the data that is then replicated to client computers 1320a, 1320b, 1320c, 1320d, 1320e, etc., although any computer can be considered a client, a server, or both, depending on the circumstances. Any of these computing devices may be processing data or requesting services or tasks that may implicate the RFID systems in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to reading and/or writing of RFID data from or to an RFID tag using the asymmetric RFID antenna designs of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 13 illustrates an exemplary networked or distributed environment, with server(s) in communication with client computer (s) via a network/bus, in which some aspects of the present invention may be employed. In more detail, a number of servers 1310a, 1310b, etc. are interconnected via a communications network/bus 1340, which may be a LAN, WAN, intranet, GSM network, the Internet, etc., with a number of client or remote computing devices 1320a, 1320b, 1320c, 1320d, 1320e, etc., such as a portable computer, handheld computer, thin client, networked appliance, or other device, such as a VCR, TV, oven, light, heater and the like in accordance with the present invention.

In a network environment in which the communications network/bus 1340 is the Internet, for example, the servers 1310a, 1310b, etc. can be Web servers with which the clients 1320a, 1320b, 1320c, 1320d, 1320e, etc. communicate via any of a number of known protocols such as HTTP. Servers 1310a, 1310b, etc. may also serve as clients 1320a, 1320b, 1320c, 1320d, 1320e, etc., as may be characteristic of a distributed computing environment.

As mentioned, communications may be wired or wireless, or a combination, where appropriate. Client devices 1320a, 1320b, 1320c, 1320d, 1320e, etc. may or may not communicate via communications network/bus 14, and may have independent communications associated therewith. For example, in the case of a TV or VCR, there may or may not be a networked aspect to the control thereof. Each client computer 1320a, 1320b, 1320c, 1320d, 1320e, etc. and server computer 1310a, 1310b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 1310a, 1310b, 1320a, 1320b, 1320c, 1320d, 1320e, etc. may be responsible for the maintenance and updating of a database 1330 or other storage element, such as a database or memory 1330 for storing data processed or saved according to the invention. Thus, some aspects of the present invention can be utilized in a computer network environment having client computers 1320a, 1320b, 1320c, 1320d, 1320e, etc. that can access and interact with a computer network/bus 1340 and server computers 1310a, 1310b, etc. that may interact with client computers 1320a, 1320b, 1320c, 1320d, 1320e, etc. and other like devices, and databases 1330.

### Exemplary Computing Device

As mentioned, the invention applies to any device wherein it may be desirable to read and/or write RFID data from or to an RFID tag using the asymmetric RFID antenna designs of the invention. It should be understood, therefore, that handheld, portable and other computing devices and computing objects of all kinds are contemplated for use in connection with the present invention, i.e., anywhere that a device may perform reading and/or writing of RFID data from or to an RFID tag using the asymmetric RFID antenna designs. Accordingly, the below general purpose remote computer described below in FIG. 14 is but one example, and some aspects of the present invention may be implemented with any client having network/bus interoperability and interaction. Thus, some aspects of the present invention may be implemented in an environment of networked hosted services in which very little or minimal client resources are implicated, e.g., a networked environment in which the client device serves merely as an interface to the network/bus, such as an object placed in an appliance.

Although not required, some of the reading or writing aspects of the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 14 thus illustrates an example of a suitable computing system environment 1400a in which some reading and or writing aspects of the invention may be implemented, although as made clear above, the computing system environment 1400a is only one example of a suitable computing environment for a media device and is not intended to suggest any limitation as to the scope of use or functionality of the invention. Neither should the computing environment 1400a be interpreted as having any dependency or requirement relating to any one or combination of components illustrated in the exemplary operating environment 1400a.

With reference to FIG. 14, an exemplary remote device for implementing the invention includes a general purpose computing device in the form of a computer 1410a. Components of computer 1410a may include, but are not limited to, a processing unit 1420a, a system memory 1430a, and a system bus 1421a that couples various system components including the system memory to the processing unit 1420a. The system bus 1421a may be any of several types of bus structures including a memory bus or memory controller, a peripheral bus, and a local bus using any of a variety of bus architectures.

Computer 1410a typically includes a variety of computer readable media. Computer readable media can be any available media that can be accessed by computer 1410a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1410a. Communication media typically embodies computer readable instructions, data structures, program modules or other data in a modulated data signal such as a carrier wave or other transport mechanism and includes any information delivery media.

The system memory 1430a may include computer storage media in the form of volatile and/or nonvolatile memory such as read only memory (ROM) and/or random access memory (RAM). A basic input/output system (BIOS), containing the basic routines that help to transfer information between elements within computer 1410a, such as during start-up, may be stored in memory 1430a. Memory 1430a typically also contains data and/or program modules that are immediately accessible to and/or presently being operated on by processing unit 1420a. By way of example, and not limitation, memory 1430a may also include an operating system, application programs, other program modules, and program data.

The computer 1410a may also include other removable/non-removable, volatile/nonvolatile computer storage media. For example, computer 1410a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1421a through a non-removable memory interface such as an interface, and a magnetic disk drive or optical disk drive is typically connected to the system bus 1421a by a removable memory interface, such as an interface.

A user may enter commands and information into the computer 1410a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1420a through user input 1440a and associated interface(s) that are coupled to the system bus 1421a, but may be connected by other interface and bus structures, such as a parallel port, game port or a universal serial bus (USB). A graphics subsystem may also be connected to the system bus 1421a. A monitor or other type of display device is also connected to the system bus 1421a via an interface, such as output interface 1450a, which may in turn communicate with video memory. In addition to a monitor, computers may also include other peripheral output devices such as speakers and a printer, which may be connected through output interface 1450a.

The computer 1410a may operate in a networked or distributed environment using logical connections to one or more other remote computers, such as remote computer 1470a, which may in turn have media capabilities different from device 1410a. The remote computer 1470a may be a personal computer, a server, a router, a network PC, a peer device or other common network node, or any other remote media consumption or transmission device, and may include any or all of the elements described above relative to the computer 1410a. The logical connections depicted in FIG. 14 include a network 1471a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1410a is connected to the LAN 1471a through a network interface or adapter. When used in a WAN networking environment, the computer 1410a typically includes a communications component, such as a modem, or other means for establishing communications over the WAN, such as the Internet. A communications component, such as a modem, which may be internal or external, may be connected to the system bus 1421a via the user input interface of input 1440a, or other appropriate mechanism. In a networked environment, program modules depicted relative to the computer 1410a, or portions thereof, may be stored in a remote memory storage device. It will be appreciated that the network connections shown and described are exemplary and other means of establishing a communications link between the computers may be used.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of some aspects of the present invention have been described in connection with various computing devices and network architectures, the underlying concepts may be applied to any computing device or system in which it is desirable to read and/or write RFID data from or to an RFID tag using the asymmetric RFID antenna designs. For instance, some aspects of the reading and writing functions of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize some aspects of the reading and/or writing capabilities of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

Some aspects of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of some aspects of the present invention. Additionally, any storage techniques used in connection with the present invention may invariably be a combination of hardware and software.

Furthermore, some aspects of the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 1-14. While for purposes of simplicity of explanation, the methodologies may be shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of systems more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms configurable to read or write RFID data, including handheld devices and associated operating systems and other application specific operating systems are contemplated, especially as the number of wireless networked devices continues to proliferate.

While exemplary embodiments refer to utilizing the present invention in the context of a exemplary type or number of components, the particular selection is intended to be illustrative and not intended to limit the claimed invention. Still further, the some aspects present invention may be implemented in or across a plurality of processing chips or devices, and storage may similarly be affected across a plurality of devices. Therefore, the present invention should not be limited to any single embodiment, but rather should be construed in breadth and scope in accordance with the appended claims.

What is claimed is:

1. A radio frequency identification (RFID) antenna for use with radio waves of a nominal wavelength, the RFID antenna comprising:
a first antenna arm comprising a variable dimension capacitive load having a first tunable RFID antenna dimension and a second tunable RFID antenna dimension, wherein the second tunable RFID antenna dimension corresponds to a RFID antenna width;
a second antenna arm comprising a folded conductor and an inductive matching stub;
wherein the folded conductor forms a closed loop with the capacitive load of the first antenna arm;
wherein a position of the inductive matching stub corresponds to a third tunable RFID antenna dimension;
wherein the third tunable RFID antenna dimension is selected to cause resonance with a selected capacitance corresponding to a capacitance of RFID tag circuitry to be used with the RFID antenna; and
wherein the first and second antenna arms are arranged to provide a greatest RFID antenna dimension of less than one quarter of the nominal wavelength of the radio waves to be used.

2. The RFID antenna of claim 1, wherein an input impedance of the RFID antenna is set such that the RFID antenna has a conjugate matching with the RFID tag circuitry, resulting in substantially optimal power transfer to a RFID tag.

3. The RFID antenna of claim 1, wherein the nominal wavelength of the radio waves substantially corresponds to the 2.4 Gigahertz (GHz) Industrial, Scientific and Medical (ISM) band.

4. The RFID antenna of claim 1, wherein the nominal wavelength of the radio waves substantially corresponds to the 900 Megahertz (MHz) Industrial, Scientific and Medical (ISM) band.

5. The RFID antenna of claim 1, wherein the RFID antenna comprises a conducting pattern substantially constructed of copper and supported by a substrate.

6. The RFID antenna of claim 3, wherein the second and third tunable RFID antenna dimensions are about 10 millimeters and 20 millimeters, respectively.

7. The RFID antenna of claim 4, wherein the second and third tunable RFID antenna dimensions are about 30 millimeters and 60 millimeters, respectively.

8. The RFID antenna of claim 1, wherein the RFID antenna is substantially impedance matched to the RFID tag circuitry by adjusting at least one of the first, second, and third tunable RFID antenna dimensions.

9. A RFID tag comprising a RFID application specific integrated circuit (ASIC) for communicatively coupling to the RFID antenna of claim 1.

10. A radio frequency identification (RFID) tag system comprising:
a RFID antenna;
RFID tag circuitry, wherein the RFID tag circuitry is at least operable to receive signals from the RFID antenna;
wherein the RFID antenna further comprises:
a first antenna element comprising a capacitive load with first and second antenna dimensions, wherein the second antenna dimension corresponds to RFID antenna width;
a second antenna element comprising a folded conductor and an inductive matching element, wherein the folded conductor forms a closed loop with the capacitive load;
wherein a location of the inductive matching element relative to the first and second antenna elements corresponds to a third antenna dimension;
wherein the third antenna dimension is adjustable to resonate with a capacitance of the RFID tag circuitry;
wherein the RFID antenna is substantially impedance matched to the RFID tag circuitry by, at least, adjusting one or more of the first, second, and third antenna dimensions.

11. The RFID tag system of claim 10, wherein the first and second antenna elements are arranged to provide a greatest RFID antenna dimension of less than one quarter of a nominal operating wavelength of the RFID tag circuitry.

12. The RFID tag system of claim 10, further comprising:
a RFID tag reader communicatively coupled to the RFID antenna and configured to send and receive radio frequency energy equivalent to a nominal operating wavelength of the RFID tag circuitry.

13. The RFID tag system of claim 10, wherein the RFID tag circuitry has impedance equivalent to 10−j200 ohms.

14. The RFID tag system of claim 11, wherein an operating wavelength of the RFID tag circuitry substantially corresponds to one of a 900 Megahertz (MHz) Industrial, Scientific and Medical (ISM) band and a 2.4 Gigahertz (GHz) Industrial, Scientific and Medical (ISM) band.

15. A method of manufacturing a radio frequency identification (RFID) antenna on a nonconductive substrate defined by an X-Y plane, the method comprising:
determining a RFID tag circuitry capacitance, impedance, and nominal operating wavelength;
selecting a capacitive load to be formed on the substrate having X-Y plane dimensions corresponding to first and second RFID antenna dimensions and that is selected to resonate with the determined RFID tag circuitry capacitance;
selecting an inductive matching stub location on the substrate, wherein the inductive matching stub location in the X-Y plane corresponds to a third RFID antenna dimension;
selecting a conductor length to be formed on the substrate adjacent to the inductive matching stub;
adjusting, at least, one or more of the first, second, and third RFID antenna dimensions to substantially match the RFID antenna impedance with the RFID tag circuitry impedance; and
forming on the substrate the conductor length, the inductive matching stub, and the capacitive load such that a closed loop is formed thereby, wherein the longest RFID antenna dimension is less than one quarter wavelength of the RFID tag circuitry operating wavelength.

16. The method of claim 15, the forming step further comprising:
forming the conductor length into a folded configuration to minimize the longest RFID antenna dimension.

17. The method of claim 15, the determining step further comprising:
determining the operating wavelength to correspond to the 900 Megahertz (MHz) Industrial, Scientific and Medical (ISM) band.

18. The method of claim 15, the determining step further comprising:
determining the operating wavelength to correspond to the 2.4 Gigahertz (GHz) Industrial, Scientific and Medical (ISM) band.

19. The method of claim 15, the forming step further comprising:
forming one or more of the conductor length, the inductive matching stub, and the capacitive load substantially from copper.

20. The method of claim 15, the determining step further comprising:
determining the RFID tag circuitry impedance to be equivalent to 10−j200 ohms.

21. An asymmetric radio frequency identification (RFID) tag antenna comprising:
a polygon-shaped capacitive load;
a folded arm that forms a closed loop with the polygon-shaped load, the folded arm having an inductive matching stub that is used to resonate with a capacitance of a chip tag, the loop having a length; and
a location for receiving the chip tag.

22. The antenna of claim 21, wherein the antenna is an ultra high frequency (UHF) tag antenna.

23. The antenna of claim 21, wherein the antenna is an antenna for a passive RFID tag.

24. The antenna of claim 21, wherein the polygon-shaped capacitive load is rectangular.

25. The antenna of claim 21, wherein the length of the loop is determined based on a function of a kind of backing material of the antenna.

26. The antenna of claim 25, wherein the kind of backing material includes one or more of cardboard, metal, plastic, cloth, ceramic, or glass.

27. The antenna of claim 21, wherein the length of the loop is determined based on proximity to a high dielectric material.

28. The antenna of claim 21, wherein the length is no greater than one quarter of an operating wavelength of the antenna.
